(19) United States
(12) Patent Application Publication
(10) Pub. No.: US 2001/0052300 A1
(43) Pub. Date: Dec. 20, 2001

(54) Pad-printing ink cup

(75) Inventor: Holger Reinholdt, Freudenstadt (DE)

Correspondence Address: Benjamin J. Hauptman, LOWE HAUPTMAN GILMAN & BERNER, LLP, Suite 310, 1700 Diagonal Road, Alexandria, VA, 22314, US

(73) Assignee: ITW Morlock GmbH

(21) Appl. No.: 09/875,951

(22) Filed: Jun. 8, 2001

(30) Foreign Application Priority Data
Jun. 9, 2000 (DE) 100 28 551.1

(51) Int. Cl. B41F 1/00

(52) U.S. Cl. 101/169

(57) ABSTRACT

The invention concerns a pad-printing ink cup fitted with at least one magnet (10). The minimum of one magnet (10) may be positioned at different heights relative to the plane of the doctor edge (22), the magnetic force effective in the said plane depending on said heights.

The invention relates to a pad-printing ink cup defined in the preamble of claim 1.

A pad-printing ink cup of this kind is known form the European patent document EP 0 347 762 B1. In a pad printing machine, the ink cup sits on a printing plate containing recesses in the form of a print picture to be transferred. The ink from the ink cup penetrates the recesses. The printing plate is displaceable underneath the ink cup and as a result the recesses constituting the picture to be transferred a first time shall be situated underneath the ink cup and another time underneath a printing pad (tampon). The pad is lowered onto the ink-filled recesses from which it removes the ink and hence the print image which it transfers—once the printing plate has been moved out of the pad's vicinity—onto an object to be printed. A pad printing machine is known for instance from the European patent document EP 0 315 769 B1, (U.S. Pat. No. 4,905,594).

The following documents contain further state of the art: DE 196 44 366 A1; DE 195 02 802 A1; DE 42 10 521 A1; DE 40 15 684 A1; EP 0 945 266 A1; WO 99 07 556 A1 and WO 93 04 862 A1.

Printing plates illustratively are made of metal or plastic.

Depending on the printing-plate surface material, a hard or soft ink cup doctor edge, shall be advantageous. The doctor edge may be constituted by the very wall of the ink cup or by means of a doctor ring affixed to the ink cup wall. The doctor edge may consist of a metal, a plastic or ceramic or another material.

Depending on the material of the printing-plate surface and of the doctor's edge, this edge may be pressed more or less hard against said surface to prevent ink from leaking between the doctor edge and the printing-plate surface. The higher the printing rate (image transfer from printing plate to an object being printed), the more rapidly the ink cup must be moved above the printing plate. However speeds entail dynamic pressures inside the doctor and there will be a commensurate danger of the ink leaking between the printing-plate surface and the doctor edge, or that it will float on the printing-plate ink (aquaplaning). As a result, and depending on the materials of the doctor edge and printing-plate surface and on the printing rate, the doctor edge may have to be pressed harder against the printing-plate surface in order to avoid unduly high friction on one hand and on the other hand to assure cleanly wiping the ink from the printing-plate surface.

The objective of the invention is to attain optimal operating conditions in simple manner. On one hand high friction and material-wear shall be avoided at the doctor edge and on the printing-plate surface. On the other hand high printing speeds—namely printing-plate speeds relative to the ink cup—shall be attained while retaining a good wiping effect of the doctor edge on the printing-plate surface.

This problem is solved by the features of claim 1 of the invention.

Consequently the invention relates to a pad-printing ink cup fitted with a cup structure open at its bottom and at the lower end of its wall with a doctor edge to wipe the ink off a printing plate, and further fitted with a magnet situated in the lower zone of the ink cup to attract this ink cup against the printing plate, said ink cup being characterized in that the minimum of one magnet is displaceable relative to the plane of the doctor edge to assume different heights from said plane, the said magnetic force effective in the doctor edge plane varying with height.

In particular the invention offers the following advantages:

The invention allows adjusting in simple manner the magnetic force by which the doctor edge is attracted against the printing-plate surface. In this manner the compression of the doctor edge against the printing-plate surface can be matched to various materials which in practice are used for the doctor edge and/or the printing-plate surface. Moreover the compression against the printing-plate surface can be matched to the various viscosities of the inks in the ink cup and deposited by said ink cup on said plate. Thus the same ink cup can be used for different kinds of printing plates. Henceforth it will no longer be necessary to use different ink cups for different printing plates. Advantageously the doctor edge shall be an exchangeable element allowing affixing different doctor edges to the ink cup wall to match different kinds of printing plates and different kinds of inks or ink viscosities.

The invention is elucidated below by means of an illustrative embodiment and in relation to the drawings.

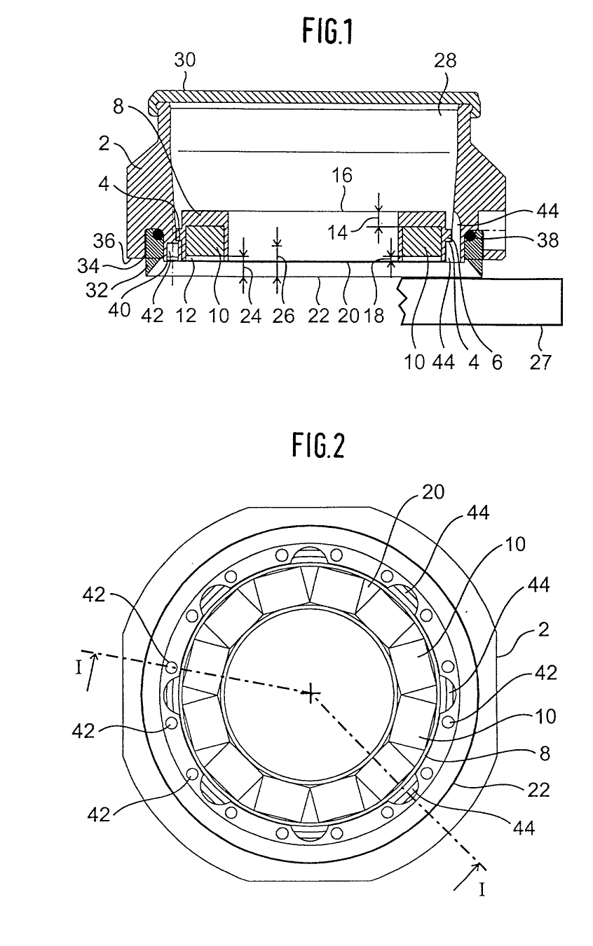

FIG. 1 is a vertical section of a pad-printing ink cup along the plane II-II of FIG. 2, and

FIG. 2 is a bottom view of the pad-printing ink cup of FIG. 1.

The pad-printing ink cup of the invention shown in the Figures comprises, as seen in horizontal cross-section, a preferably substantially cylindrical wall 2 fitted at its inside and in the lower zone with an annular salient 4 (offset) projecting radially inward and supporting an annular external circumferential rib 6 of a an annular magnet holder 8. A plurality of permanent magnets 10 is integrated into the annular magnet holder and preferably these are bonded in place by a curing adhesive 12. Instead of an annular salient 4 running over 360° and/or an annular external circumferential rib 6, salients or ribs running over only a small part of the circumference may also be used.

The external circumferential rib 6 is situated approximately at the half-height of the annular magnet holder 8. The height differential 14 between the permanent magnets 10 and the top side 16 of the annular magnet holder 8 is larger than their distance 18 to the bottom side 20 of the annular magnet holder 8. Therefore the height differential between the permanent magnets 10 and the plane containing a doctor edge 22 is a lesser height differential 24 in the embodiment of FIG. 1 when the top side 16 of the annular magnet holder 8 points upward than in a reversed position of the annular magnet holder 8 wherein its top side 18 points down, and its bottom side 20 points up, resulting in a larger height differential 26 between the permanent magnets 10 and the plane of the doctor edge 22.

Accordingly the force exerted by the permanent magnets 10 in their upright positions shown in the plane of the doctor edge 22 in FIG. 1 shall be larger than in the omitted, that is the upside down position of the annular magnet holder 8. In one case the doctor edge 22 (FIG. 1) is attracted more strongly and in the other case more weakly toward the surface of a printing plate 27 against the surface of a printing plate by a magnetizable body, in particular iron, which may be the printing plate per se or another part added to it, preferably underneath.

The height differentials and the height of the external circumferential rib 6 relating to the top side 16 and bottom side 20 of the annular magnet holder 8 determine the magnetic force in the upright position shown in FIG. 1 and in the omitted, upside down position of the annular magnet holder 8.

The distance between the permanent magnets 10 and the doctor edge 22 also can be adjusted using annular spacers between the annular inner salient 6 of the cup wall 2 and the external circumferential rib 6 and thereby also the magnetic force in the plane of the doctor edge.

The ink cup is wide open at the bottom and the ink it contains can freely flow down through the annular magnet holder 8 onto a permitting plate 27. The ink cup also comprises an open upper end 28 which can be sealed by a lid 30 attached to the cup wall 2 and be reopened to refill ink into the cup.

The doctor edge 22 may consist of the lower end of the cup wall 2. In the shown, preferred embodiment, the doctor edge 22 assumes the form of an annular doctor 32 inserted in exchangeable manner into an annular channel 34 in the lower end face 36 of the cup wall 32 and illustratively being sealed by a seal 38.

Magnetizable metal, preferably iron pins 42 are inserted into boreholes 40 in the lower end face 36 and are magnetically attracted by the permanent magnets 10. As a result the annular magnet holder 8, that is its external circumferential rib 6, is magnetically pulled down against the magnetic salient 4 of the cup wall 2 and thereby it is also retained at said annular salient 4 both in the cup's axial and circumferential direction, when the ink cup is turned upside down. The permanent magnets 10 might be replaced by electromagnetic ones, though this feature so far remains unconventional.

A plurality of circumferentially distributed overflow ducts 44 are present between the cup wall 2 and the annular magnet holder 8 and run from the bottom side 20 to the top side 16 of said holder 8, allowing ink subjected to dynamic pressure during doctoring to flow from the inside of the doctor edge 22 through these ducts from the bottom side 20 to the top side 16. In the embodiment shown in the Figures, the overflow ducts 44 are in the form of channels running axially in the inside of the cup wall 2 and opposite the annular magnet holder 8. In another embodiment mode, such ducts also may instead or additionally be present in the annular magnet holder 8.

When seen in horizontal cross section, the cup wall 2 preferably exhibits a cylindrical cross-section, though this cross-sectional contour may vary in other embodiment modes. Preferably the cup wall 2 is made of a non-magnetic material such as aluminum or plastic.

1. A pad-printing ink cup, exhibiting a cup structure open at the bottom and fitted with a doctor edge (22) at the lower end of its cup wall (2) to wipe off the ink on a printing plate, and fitted with at least one magnet (10) configured in the lower zone of and inside the cup structure to magnetically attract the cup structure against the printing plate,
characterized in that
the minimum of one magnet (10) is affixed to an annular magnet holder (8), in that the cup structure is open or can be opened (28) at the top and in that the annular magnet holder (8) can be inserted from above into the cup structure and can rest on an inside salient (4) of the cup structure wall (2), in that the minimum of one magnet (10) can be positioned at different heights relative to the plane containing the doctor edge (22), the magnetic force effective in the plane of the doctor edge varying with distance.

2. Pad-printing ink cup as claimed in claim 1, characterized in that the annular magnet holder (8) comprises a top side (16) and a bottom side (20) and can be configured alternatively at the cup wall (2) with its top side (16) facing upward or being reversed so that its top side (16) faces downward, and in that the minimum of one magnet (10) assumes different heights relative to the plane of the doctor edge for one of said configurations compared with the other.

3. Pad-printing ink cup as claimed in either of claims 1 and 2, characterized in that spacers can be inserted between the inner salient (4) and the annular magnet holder (8) in order to adjust the spacing between the minimum of one magnet (10) and the doctor edge (22).

4. Pad-printing ink cup as claimed in one of the above claims, characterized in that the minimum of one magnet (10) is a permanent magnet.

5. Pad-printing ink cup as claimed in one of the above claims, characterized in that the cup wall (2) is made of a non-magnetizing material.

6. Pad-printing ink cup as claimed in claim 5, characterized in that at least one magnetizing element (42) magnetically attracting at least a first magnet (10) is affixed to the cup wall (2) and shall retain the minimum of one magnet (10) in its height-adjusted position relative to the cup wall (2) even when the ink cup is turned upside down.

7. Pad-printing ink cup as claimed in one of the above claims, characterized in that overflow ducts (44) are configured between the cup wall (2) and the annular magnet holder (8) mounted on the inside of said cup wall to allow ink from the inside of the doctor edge (22) to flow through said ducts from the bottom side (20) to the top side (16) of the annular magnet holder (8) when said ink is pressurized by dynamic pressure during doctor operation.

8. Pad-printing ink cup as claimed in one of the above claims, characterized in that the doctor edge (22) is exchangeably mounted on the cup wall (2).
